(19) United States
(12) Patent Application Publication
(10) Pub. No.: US 2022/0339567 A1
(43) Pub. Date: Oct. 27, 2022

(54) A METHOD FOR PREPARING A COMPOSITE FILTER MEDIUM AND THE COMPOSITE FILTER MEDIUM OBTAINED WITH THIS METHOD

(71) Applicant: SAATI S.P.A., Appiano Gentile (IT)

(72) Inventors: Roberto MOMENTE, Appiano Gentile (IT); Carmine LUCIGNANO, Appiano Gentile (IT); Martina SIMONE, Appiano Gentile (IT); Paolo CANONICO, Appiano Gentile (IT)

(21) Appl. No.: 17/753,370

(22) PCT Filed: Oct. 21, 2020
(86) PCT No.: PCT/IB2020/059890

§ 371 Date: Mar. 1, 2022

(30) Foreign Application Priority Data
Oct. 24, 2019 (IT) 102019000019760
Oct. 19, 2020 (IT) 102020000024589

(51) Int. Cl. B01D 39/08

(52) U.S. Cl. CPC B01D 39/083; B01D 2239/025; B01D 2239/0421; B01D 2239/0428; B01D 2239/0442; B01D 2239/0478; B01D 2239/0631; B01D 2239/0654; B01D 2239/10; B01D 2239/1233; B01D 2279/45; B01D 2239/1291

(57) ABSTRACT

A method for preparing a composite filter medium (1), comprising a step of forming a first filter medium (8) through deposition of nanofibers (4) on a base fabric (2) through an electrospinning process and a step of covering said filter medium (1) by plasma deposition of a coating (7) on said first filter medium (8) in a vacuum chamber (9). According to the invention, after the electrospinning process and before the plasma deposition of the coating (7), a degassing step of the base fabric (2) and of the nanofibers (4) forming the aforementioned first filter medium (8) is provided inside the same chamber (9). With respect to the known filter media, that of the invention offers the advantage of maintaining the desired level of water and oil repellency, due to the formation of a completely polymerized coating strongly adhering to the surface of the base fabric and of the nanofibers.

### BACKGROUND OF THE INVENTION

The present invention relates to a method for preparing a composite filter medium. The invention also extends to the composite filter medium obtained with this method.

The field of the invention is that of composite filter media, in particular those used for protection against the intrusion of dirt particles and for repelling liquids in general such as water and oils, so as to ensure a high permeability to air, i.e. a low acoustic impedance, for the best sound transfer; for example, in consumer electronics appliances, especially the electroacoustic components of mobile phones.

Known composite filter media are formed by a combination of at least one layer of nanofibers supported by a weft and warp base fabric, in which the nanofiber layer is deposited on the base fabric by means of an electrospinning process and in which a plasma coating is applied to the base fabric and the nanofibers. This method produces a composite filter medium in which the nanofiber layer adheres to the base fabric.

In order for the plasma coating to ensure the desired performance, it is essential that the monomer, injected into the plasma system chamber, polymerizes on the surface of the base fabric and the nanofibers under optimum conditions. These polymerization conditions depend, however, on the process parameters set for the plasma treatment, such as the power of the electrical source, the sealing pressure in the vacuum chamber, the time of exposure of the fibers to the plasma treatment, the distance of the substrate from the electrodes, and others.

During the above described plasma treatment, the pressure in the vacuum chamber may undergo variations with respect to the value set, in particular, it may increase due to the gas released by the material being processed inside the vacuum chamber. The reason why the pressure inside the chamber rises, during the plasma process for the formation of a coating on the surface of the base fabric and the nanofibers, is mainly attributable to the moisture content of the material placed in the vacuum chamber. In fact, during this treatment, the water molecules leave the fibrous material to be coated, causing an increase in pressure, mixing with the coating plasma feeding gas, thus contaminating it. This becomes even more critical when working on rolls of material with a large diameter and a heavy weight, that is, in industrial production processes.

Such an increase in pressure inevitably changes the polymerization conditions of the material that forms the coating of the base fabric and the nanofibers, causing an incomplete polymerization of the coating, which, in turn, results in a failure to lower the surface energy of the nanofibers and therefore a failure to achieve the desired water and oil repellency in the final filter medium.

The contamination of the coating plasma feeding gas, caused by the water molecules released by the fabric, alters the polymerization reaction, thus generating a coating with chemical-physical properties less performing than those of the desired water- and oil-repellent coating and not ensuring a sufficient adhesion of the polymerized coating to the substrate.

### SUMMARY OF THE INVENTION

The main purpose of the present invention is to provide a composite filter medium and its manufacturing process which, with respect to the known filter media of this type, ensures optimal polymerization of the coating deposited on the surface of the monofilament forming the base fabric and on the surface of the nanofibers.

It is also an object of the invention to provide a process for manufacturing a filter medium which has a coating that strongly adheres to the surface of the monofilaments of the base fabric and the surface of the nanofibers.

These and other objects are achieved with the method and filter medium of claims 1 and 10, respectively. Preferred embodiments of the invention will be apparent from the remaining claims.

With respect to the known filter media, that of the invention offers the advantage of maintaining the desired level of water and oil repellency, due to the formation of a completely polymerized coating strongly adhering to the surface of the base fabric and the nanofibers.

The composite filter medium of the invention, in which the individual nanofibers and the individual threads of the fabric are covered with a thin highly hydrophobic and oleophobic coating, also has the ability to expel dirt and, in particular, liquids, not just water (high surface tension, 72 mN/m), but also liquids such as oils with a low surface tension (30-40 mN/m). This property of the filter medium of the invention is particularly useful in its applications as a protective screen for electroacoustic components, in particular of mobile phones. In fact, the filter medium of the invention consists of nanofibers, which offer a very high permeability to air (and a very low acoustic impedance), thus ensuring effective protection against the intrusion of particles. Moreover, due to its particular coating, the composite filter medium of the invention prevents the infiltration of water, oils and other types of liquid. In fact, the filter medium of the invention not only prevents the infiltration of these liquids but is easier to clean due to its water repellency.

### BRIEF DESCRIPTION OF THE DRAWINGS

These and other objects, advantages and features will be apparent from the following description of a preferred embodiment of the method and the filter medium according to the invention illustrated by way of a non-limiting example in the figures in the attached drawings.

In these:

FIG. 1 is a sectional and schematic view of an example of a composite filter medium of the invention;

FIG. 2 shows a detailed drawing of the nanofibers deposited by electrospinning on a corresponding thread of base fabric, in which both the nanofibers and the threads of the base fabric are all coated with a nanometric layer of water-and oil-repellent polymer, applied by plasma treatment;

FIG. 3 illustrates the electrospinning method for making a layer of nanofibers in the filter medium of the invention;

FIG. 4 schematically illustrates the plasma treatment of the filter medium of the invention, obtained by depositing the nanofiber layer made by an electrospinning process on a base fabric;

FIG. 5 illustrates the relationship between the flow rate and the pressure measured across the filter medium for the dry sample and the wet sample;

FIG. 6 illustrates the relationship between the emptying pressure and the corresponding pressure drop for the declogging test carried out on two different samples.

### DESCRIPTION OF THE PREFERRED EMBODIMENTS

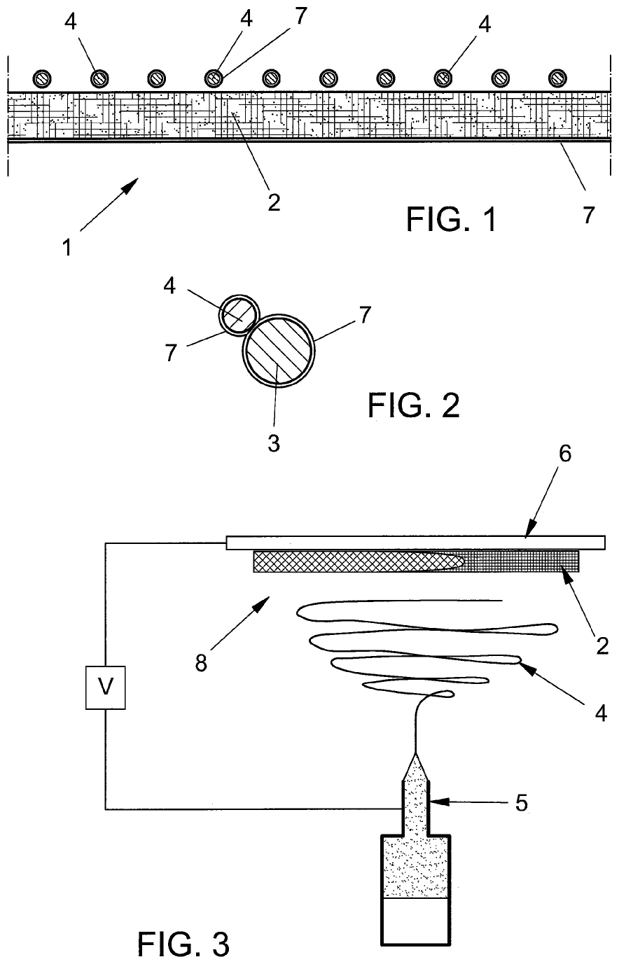

The composite filter medium of the invention, indicated as a whole by the number 1 in FIG. 1, comprises a support formed by a base fabric 2 of the warp and weft type, preferably a monofilament fabric, on the surface of which nanofibers 4 are deposited by electrospinning. Suitable for the invention are the monofilaments 3 made starting from monofilaments of polyester, polyamide, polypropylene, polyether sulfone, polyimide, polyamide imide, polyphenylene sulfide, polyether ether ketone, polyvinylidene fluoride, polytetrafluoroethylene, aramid, with a mesh opening of the base fabric 2 in a range from 2500 microns to 5 microns.

The base fabric used in the preparation of the composite filter medium of the invention is selected from a wide range of synthetic monofilament fabrics, which differ in the chemical nature of the monofilament used for weaving, such as polyester, polyamide, polypropylene, polyether sulfone, polyimide, polyamide imide, polyphenylene sulfide, polyether ether ketone, polyvinylidene fluoride, polytetrafluoroethylene, aramid. Also suitable for the invention are base fabrics with textile construction of 4-300 threads/cm, thread diameter of 10-500 microns, weave with a weight of 15-300 g/m² and thickness of 18-1000 microns. For finishing and further surface treatments, in addition to metallization, use can be made of washed and heat-set “white” fabric, colored fabric, fabric subjected to plasma treatment, hydrophobic, hydrophilic, antibacterial, antistatic fabric and the like. Preferred for the invention is a polyester monofilament fabric, with 48 threads/cm, diameter 55 μm, mesh opening of the base fabric of 153 μm.

Suitable for the invention are nanofibers 4 of polyester, polyurethane, polyamide, polyimide, polypropylene, polysulfone, polyether sulfone, polyamide imide, polyphenylene sulfide, polyether ether ketone, polyvinylidene fluoride, polytetrafluoroethylene, alginate, polycarbonate, PVA (polyvinyl alcohol), PLA (polylactic acid), PAN (polyacrylonitrile), PEVA (polyethylene vinyl acetate), PMMA polymethyl methacrylate), PEO (polyethylene oxide), PE (polyethylene), PVC, PEI, PUR and polystyrene. These nanofibers can have a diameter of between 50 nm and 700 nm. PVDF (polyvinylidene fluoride) nanofibers with a diameter ranging from 75 to 200 nm are preferred.

As illustrated in FIG. 3, the electrospinning process for the formation of the nanofibers 4 and their subsequent deposition on the base fabric 2, consists in injecting the material for the formation of the nanofibers 4, dissolved in a suitable solvent, through a nozzle 5 in order to spread it on an electrode 6. Due to the difference in potential between the nozzle 5 and the electrode 6, the nanofibers 4 are formed through evaporation of the solvent, due to the electric field and stretching of the polymer deposited on the electrode, by means of the nozzle. The nanofibers thus formed are then stretched and subsequently deposited on the base fabric 2.

The composite filter medium obtained in this way is then subjected to a surface treatment by plasma deposition of a polymeric layer 7 of nanometric thickness on the exposed surfaces of the fabric 2 and of the nanofiber layer 4, completely covering the external surfaces of the monofilaments 3 of the base fabric 2 and of the aforementioned nanofibers 4 (FIG. 2).

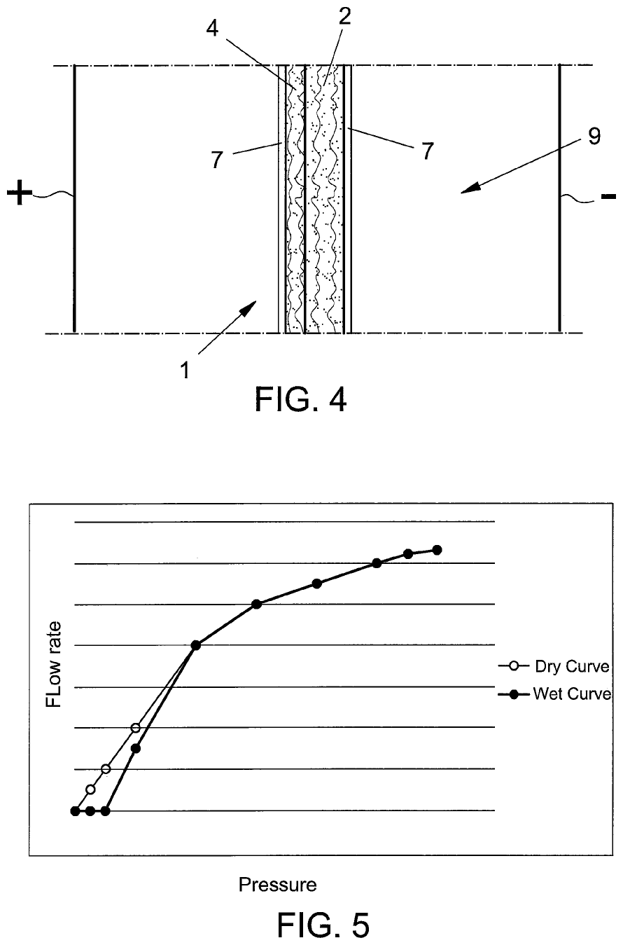

As shown in FIG. 4, the composite filter medium 8, obtained from the previous electrospinning process of FIG. 3, is arranged inside a plasma treatment chamber 9, in the presence of a gas forming the aforementioned coating 7 so as to cover the composite filter medium 1 of the invention.

Preferred for the invention are gases based on fluorocarbon acrylates, in particular, heptadecafluorodecyl acrylate, perfluorooctylacrylate and the like. Advantageous for the invention are the gases forming by plasma treatment a deposit of fluorocarbon acrylates, due to their water- and oil-repellent properties.

In the plasma treatment described above, a carrier gas is also used, for example the type described in WO2011089009A1.

The aforementioned plasma treatment involves the creation of a vacuum of 10-50 mTorr, an electrode power of 150-350 W and an exposure time of 0.5-6 minutes.

The coating deposited by means of plasma technology can have a thickness of up to 500 nm and, due to the particular technology used, has the structure of a continuous film, capable of coating even 3D surfaces like those of a fabric. Depending on the chemical compound used, the aforementioned coating can have various peculiar characteristics, such as hydrophobicity, oleophobicity, hydrophilicity and antistaticity.

Preferred for the invention are the coatings obtained starting from the following chemical compounds in the starting gases:

1H,1H,2H,2H-HEPTADECAFLUORODECYL ACRYLATE (CAS #27905-45-9, H₂C═CHCO₂CH₂CH₂(CF₂)₇CF₃)

1H,1H,2H,2H-PERFLUOROOCTYL ACRYLATE (CAS #17527-29-6, H₂C═CHCO₂CH₂CH₂(CF₂)₅CF₃)

The thickness of the coating 7 is 15-60 nm, suitable to prevent it from excessively narrowing the pores that the composite filter medium 1 forms in both the fabric 2 and the nanofibers 4, which would hinder the free passage of sound.

Tests were carried out on composite filter medium 8, as obtained from the electrospinning process of FIG. 3, compared with the analogous composite filter medium 1 that was subjected to the subsequent plasma treatment of FIG. 4.

In particular, the aforementioned filter medium 8 is formed by a weft and warp fabric made of synthetic monofilament 3 (for example of polyester), on which nanofibers 4, also made of synthetic material (for example polyester), have been deposited, in order to obtain an acoustic impedance of 25 MKS Rayls, measured with the Textest instrument or similar for measuring the acoustic impedance/air permeability.

After plasma treatment of the filter medium 8, it can be observed, on the composite filter medium 1 of the invention, that the acoustic impedance remains unchanged at values of 25 MKS Rayls. The air permeability value of 5,200 l/m²s at a pressure of 200 Pa and the filtration efficiency also remain unchanged.

On the other hand, a considerable increase is observed both in the angle of contact with water (from 50° to 130°), and in the angle of contact with oil (from 50° to 120° for an oil with corn oil having a surface tension of 32 mN/m), where the angle of contact is measured on a drop of water or oil with the nanofibers 4, using the sessile method with Kruss instruments (drop deposition and measurement of the angle of contact by means of high resolution camera).

Declogging Test

In order to provide evidence of the observations set out above, a test method was developed with a view to numerically quantifying the energy necessary to remove the oil deposited on the surface of the composite filter medium of the invention.

This test was carried out with a porometer (PMI 1200, manufactured by PMI), an instrument that uses capillary flow porometry to determine the bubble point, the minimum pore size and the distribution of the pore size on the sample tested. Capillary flow porometry, or simply porometry, is based on an extremely simple principle: measuring the pressure of a gas necessary to force the passage of a wetting liquid through the pores of the material. The pressure at which zo the pores empty is inversely proportional to the size of the pores themselves. Large pores require low pressures while small pores require high pressures.

The test consists in cutting the sample to be analyzed and placing it inside the test chamber. Subsequently the sample is held in position by means of O-rings, in such a way as to be sure there are no lateral air leaks. Once the chamber is closed, the air permeability of the filter medium is measured, obtaining a curve that puts the air flow through the sample in relation with the pressure drop measured across the filter medium (dry curve in the graph in FIG. 5). Once the dry curve has been obtained, the test chamber is opened and, leaving the sample in position, its surface is covered with a test liquid having a low surface tension (typically <20 mN/m). The test chamber is then closed and the air permeability of the material is measured again. As the material is occluded by the test liquid, the pressure will increase, but no air flow will be measured downstream, until the pressure is high enough to force the liquid to pass through the pores. From this moment on, the pores of decreasing size will be emptied with increasing pressure values until the sample (previously wet) is completely dry and the two curves of FIG. 5 overlap. Without going into analytical details, on a qualitative level, from the difference between the two curves, the bubble point value (largest pore), the size of the smallest pore and the distribution of the pore size can be determined.

In the specific case, in order to determine the oil repellency/removal capacity, this test was carried out but using corn oil (surface tension 32 mN/m) in place of the test liquid.

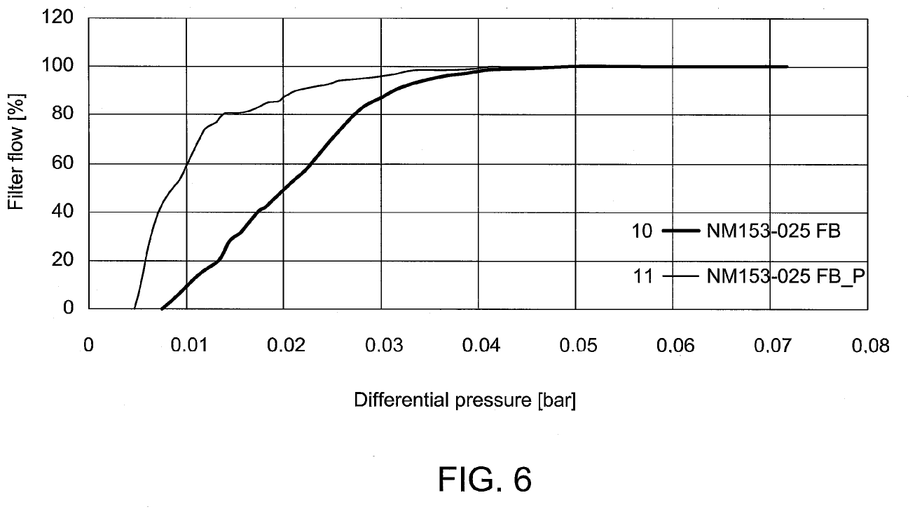

The graph in FIG. 6 shows the emptying pressure and the corresponding pressure drop (energy required for emptying). The samples considered in the graph in FIG. 6 are the filter medium 8 from electrospinning treatment (curve 10) and the filter medium 1 of the invention (curve 11). It can be seen that with the filter medium 1 of the invention, the oil can be removed at decidedly lower pressures or, at the same pressure, a decidedly larger amount of oil is removed than with the composite filter medium 8, which has not undergone the plasma treatment.

According to the invention, it has now surprisingly been discovered that, by adding to the method described above a preliminary step of degassing the material forming the monofilament 3 and the nanofibers 4 of the composite filter medium 8 to be treated in the vacuum chamber and a subsequent plasma treatment, performed prior to the step of formation of the coating 7, complete polymerization and strong adhesion of the coating subsequently deposited on the monofilament forming the base fabric and on the nanofibers are achieved.

In particular, according to the invention, prior to the step of formation of the plasma coating 7, a degassing step of the filter medium 8 obtained in the previous electrospinning process is carried out in the chamber 9, so as to bring the pressure in the chamber 9 to a value of 5-250 mTorr. For this purpose, depending on the size, weight and hygroscopicity of the material to be treated, a degassing step should be provided having an exposure time of the material typically in a range from 5 seconds to 5 minutes. Of course, once the proper exposure time, allowing a complete drying of the media, is defined, i.e. a time ensuring a stable vacuum degree in the subsequent coating step, the correct speed for the degassing step shall be set, depending on the exposed area within the chamber. Such area is defined by the distance between unwinding and winding cylinders and by the electrode size. In particular, if a material is packaged in rolls, it will be continuously unwound and rewound inside the chamber 9 at a speed of between 0.1 and 50 m/min depending on the moisture content of the material. An opening, suitably controlled by a system of valves, will be provided in the chamber 9 so that the gases to be eliminated can be vented.

According to the invention, the preliminary check on the aforementioned pressure values will allow the moisture contained in the material to be treated in the chamber 9 to be removed completely so as to allow the desired polymerization pressure of the coating 7 on the surface of the base fabric and the nanofibers to be reached, in the subsequent step of formation of said coating.

Furthermore, according to the invention, after the degassing treatment described above and again prior to the step of formation of the coating 7, the surfaces of the monofilament 3 forming the base fabric 2 and of the nanofibers 4 are reactivated in the chamber 9, by means of a plasma treatment performed in the chamber 9 maintained at a pressure of 10-400 mTorr, with an electrode power in a range of 100-2000 W and an exposure time in a range of 5 seconds to 5 minutes, with a carrier gas, preferably selected from nitrogen, helium, argon and oxygen. Depending on the gas used, the exposure time and the power, a more or less marked etching effect will be obtained, resulting in the formation of a nanometric/micrometric roughness on the surface to be treated.

In this step there is no formation of any coating on the treated surfaces, as the polymeric monomer is not present. On the contrary, the ions coming from the carrier gas, duly energized by the plasma, impact with some energy on the surface of the substrate, creating nanogrooves and consequently nanometric roughness, which favors the grip and adhesion of the polymer coating 7 to the surface of the monofilament 3 and the nanofibers 4, contributing significantly to the repellent action of the filter medium towards water and oily liquids.

The results offered by the filter medium made with the process of the invention are shown in the following table, the values of which were measured on a filter medium having a layer 7 of polymeric material, obtained by performing the plasma treatment for the formation of the latter after:
a degassing step, carried out by keeping the material to be treated inside the chamber 9 for a time of 30 seconds, suitable to ensure a stable pressure of 25 mTorr in the subsequent treatment;
and, subsequently, a step of plasma treatment of the material to be coated, carried out in the presence of helium as a carrier gas, with a vacuum of 150 mTorr, an electrode power of 600 W and an exposure time of 1 minute:

| | | Minimum angle |
|---|---|---|
| | | of contact required |
| | Angle of contact | for the application |
| | with oil (°) | (°) |
| Electrospinning process + | 130-135 | 110 |
| plasma deposition without | | |
| degassing and without plasma | | |
| pretreatment (known technique) | | |
| Electrospinning process + | 115 | 110 |
| degassing + preliminary plasma | | |
| treatment + deposition of | | |
| plasma coating (invention) | | |

From these results it can be seen how the polymeric coating 7 formed in the vacuum chamber 9 after a degassing step and a preliminary plasma treatment, ensures the filter medium of the invention a very high angle of contact with oil (>110°), and a much higher adhesion level to the substrate than the minimum required.

In the invention as described above and illustrated in the figures in the attached drawings, changes may be made in order to produce variants which nevertheless fall within the scope of the appended claims.

In particular, when the filter medium is made starting from slightly hygroscopic materials and is to be subjected to the plasma deposition process, it is possible to perform the reactivation step alone by plasma treatment and with a carrier gas, again selected from nitrogen, helium, argon and oxygen. In fact, for this type of slightly hygroscopic materials, the above-described preliminary degassing step can be omitted.

1. A method for preparing a composite filter medium (1), comprising a step of forming a first filter medium (8) through deposition of nanofibers (4) on a base fabric (2) by means of an electrospinning process and a step of covering said filter medium (1) by plasma deposition of a coating (7) on said first filter medium (8) in a vacuum chamber (9), characterized in that said method provides, after said electrospinning process and before said plasma deposition of the coating (7), a degassing step of the base fabric (2) and the nanofibers (4) forming the aforementioned first filter medium (8) inside the same chamber (9).

2. The method according to claim 1, characterized in that, during said degassing step, the aforementioned chamber (9) is brought to an internal pressure value of between 5 and 250 mTorr.

3. The method according to claim 1, characterized in that, during said degassing step, an exposure time in the chamber from 5 seconds to 5 minutes is ensured for the material.

4. The method according to claim 1, characterized in that, after the aforementioned degassing step and before said plasma deposition of the coating (7), it also provides a step of formation of irregularities on the surface of said base fabric (2) and of the aforementioned nanofibers (4), through plasma treatment of said first filter medium (8) obtained in the previous degassing step, carried out in said chamber (9) in the presence of a carrier gas and without any polymer-containing gases.

5. The method according to claim 4, characterized in that the aforementioned carrier gas is selected from nitrogen, helium, argon or oxygen.

6. The method according to claim 5, characterized in that the aforementioned plasma treatment is performed in the chamber (9) at a pressure of 10-400 mTorr, with an electrode power of 100-2000 W and with an exposure time of between 5 seconds and 5 minutes.

7. The method according to claim 1, characterized in that the electrospinning process involves the extrusion of polymer dissolved in a suitable solvent, by means of a nozzle (5) and subsequent stretching of the fibers between the nozzle itself and an electrode, thus obtaining a deposition of nanometric fibers on the base fabric, suitably interposed between the nozzle and the electrode, the filter medium (8) thus obtained being subsequently subjected to a surface treatment through plasma deposition of a polymeric layer (7) of nanometric thickness on the exposed surfaces of the base fabric (2) and of the nanofiber layer (4), obtaining the aforementioned composite filter medium (1) in which the external surfaces of the monofilaments (3) of the base fabric (2) and of the aforementioned nanofibers (4) are coated with said polymeric layer (7).

8. The method according to claim 7, characterized in that the aforementioned plasma deposition treatment comprises the creation of a vacuum of 10-50 mTorr, an electrode power of 150-350 W and an exposure time of 0.5-6 minutes.

9. A method for preparing a composite filter medium (1), comprising a step of forming a first filter medium (8) through deposition of nanofibers (4) on a base fabric (2) by means of an electrospinning process and a step of covering said filter medium (1) by plasma deposition of a coating (7) on said first filter medium (8) in a vacuum chamber (9), characterized in that said method provides, after said electrospinning process and before said plasma deposition of the coating (7), a step of forming irregularities on the surface of said base fabric (2) and of said nanofibers (4), through plasma treatment of said first filter medium (8) carried out in said chamber (9) in the presence of a carrier gas and without any polymer-containing gases.

10. A composite filter medium, of the type comprising a base fabric (2) on which nanofibers (4) are deposited, characterized in that said base fabric and the aforementioned nanofibers are covered with a nanometric coating layer (7), applied by means of a plasma process, the base fabric (2) and the nanofibers (4) having nanogrooves obtained through plasma treatment in the presence of a carrier gas and without any polymer-containing gases.

11. The filter medium according to claim 10, characterized in that the aforementioned coating (7) is formed by a film having a thickness of up to 500 nm, preferably with a thickness of 15-60 nm.

12. The filter medium according to claim 10, characterized in that the aforementioned coating (7) is a coating based on fluorocarbon acrylates with water- and oil-repellent properties.

13. The filter medium according to claim 10, characterized in that said monofilaments (3) are made starting from monofilament of polyester, polyamide, polo ypropylene, polyether sulfone, polyimide, polyamide imide, polyphenylene sulfide, polyether ether ketone, polyvinylidene fluoride, polytetrafluoroethylene, aramid.

14. The filter medium according to claim 10, characterized in that the aforementioned base fabric (2) has a mesh opening of 2500-5 microns.

15. The filter medium according to claim 10, characterized in that the aforementioned base fabric (2) has a textile construction of 4-300 threads/cm, thread diameter of 10-500 microns, weave with a weight of 15-300 g/m² and thickness of 18-1000 microns.

16. The filter medium according to claim 10, characterized in that the aforementioned nanofibers (4) are nanofibers of polyester, polyurethane, polyamide, polyimide, polypropylene, polysulfone, polyether sulfone, polyamide imide, polyphenylene sulfide, polyether ether ketone, polyvinylidene fluoride, polytetrafluoroethylene, alginate, polycarbonate, PVA (polyvinyl alcohol), PLA (polylactic acid), PAN (polyacrylonitrile), PEVA (polyethylene vinyl acetate), PMMA polymethyl methacrylate), PEO (polyethylene oxide), PE (polyethylene), PVC, PI or polystyrene.

17. The filter medium according to claim 10, characterized in that said nanofibers (4) have a diameter of between 50 nm and 700 nm, preferably they are PVDF (polyvinylidene fluoride) nanofibers with a diameter ranging from 75 to 200 nm.

18. Use of the filter medium according to one or more of the preceding claims for the protection of electroacoustic components in mobile phones.
